(19) United States
(12) Patent Application Publication
(10) Pub. No.: US 2017/0253133 A1
(43) Pub. Date: Sep. 7, 2017

(54) SOLAR POWERED VEHICLE INTEGRATED BATTERY CHARGER

(71) Applicant: Kevin David Taylor, Princeton (CA)

(72) Inventor: Kevin David Taylor, Princeton (CA)

(21) Appl. No.: 15/062,523

(22) Filed: Mar. 7, 2016

(51) Int. Cl. B60L 11/18

(52) U.S. Cl. CPC B60L 11/1812; B60L 11/1816; B60L 11/1838

(57) ABSTRACT

An integrated battery charger, comprising: a) a battery charger, comprising i) a solar panel positioned to generate electricity when the solar panel is exposed to said ambient light, the solar panel being operable to charge a battery, and ii) one or more cables in electrical communication with a motorcycle battery, an ATV (all-terrain vehicle) battery, a UTV (utility-terrain vehicle) battery or a personal watercraft battery, wherein the battery charger is integrated into a motorcycle, an ATV (all-terrain vehicle), a UTV (utility-terrain vehicle) or a personal watercraft.

### FIELD OF THE INVENTION

The present disclosure is in the field of vehicle integrated solar powered battery chargers.

### BACKGROUND OF THE DISCLOSURE

Motorcycles, snowmobiles, ATVs (all-terrain vehicle), UTVs (utility-terrain vehicle) or personal watercraft often remain idle for extended periods and their batteries can run down to a low charge condition that is too weak to start the engine. If that happens, the user often connects a battery charger. This action often requires removing the seat of other articles of the vehicle to access the battery. After starting the engine, the user disconnects the battery charger for storage until it is needed again.

Unfortunately, these types of recreational or utility types vehicles often remain idle which means the cycle will occur again, whereby the user must go through the steps of removing the seat, etc., connecting the charger to the battery, charge the battery, remove the battery charger, reattached the seat, etc., and storing the battery charger.

Therefore, there is a need for an integrated battery charger that employs a solar cell that automatically maintains the charge of the battery in vehicles with intermittent use.

### SUMMARY OF THE INVENTION

An integrated battery charger, comprising: a) a battery charger, comprising i) a solar panel positioned to generate electricity when the solar panel is exposed to said ambient light, the solar panel being operable to charge a battery, and ii) one or more cables in electrical communication with a motorcycle battery, a snowmobile battery, an ATV (all-terrain vehicle) battery, a UTV (utility-terrain vehicle) battery or a personal watercraft battery, wherein the battery charger is integrated into a motorcycle, a snowmobile, an ATV (all-terrain vehicle), a UTV (utility-terrain vehicle) or a personal watercraft.

A method of maintaining a charge on a battery, comprising: a) providing a battery charger, comprising i) a solar panel on said support positioned to generate electricity when said support is exposed to said ambient light, said solar panel being operable to charge said booster battery when so exposed, and ii) one or more cables capable of being in electrical communication with a motorcycle battery, a snowmobile battery, an ATV (all-terrain vehicle) battery, a UTV (utility-terrain vehicle) battery or a personal watercraft battery, wherein the solar panel is integrated with a motorcycle hand guard, a solar panel integrated with a snowmobile hand guard, a solar panel integrated with an ATV hand guard, a solar panel integrated with a motorcycle mirror, a solar panel integrated with an ATV mirror, a solar panel integrated with a personal watercraft steering pad and/or a personal watercraft steering pad cover, a UTV roof, a motorcycle saddle bag or an ATV trunk; b) switching the motorcycle, snowmobile, ATV, personal watercraft or UTV ignition to an off position; and c) charging the battery via the battery charger with the solar panel exposed to sunlight.

### BRIEF DESCRIPTION OF THE DRAWINGS

FIG. 1 is an illustration of a motorcycle, snowmobile or an ATV (all-terrain vehicle) 108 comprising an integrated battery charger comprising a motorcycle hand guard, a snowmobile hand guard or an ATV hand guard affixed to a handlebar 110.

FIG. 2 is an illustration of a motorcycle, an ATV (all-terrain vehicle) or a UTV (utility-terrain vehicle) 210 comprising an integrated battery charger comprising a motorcycle mirror, an ATV mirror or a UTV mirror affixed to a bar 212.

FIG. 3 is an illustration of a personal watercraft 308 comprising an integrated battery charger comprising a personal watercraft steering pad and/or a personal watercraft steering pad cover.

FIG. 4 is an illustration of a UTV (utility-terrain vehicle) 408 comprising an integrated battery charger comprising a UTV roof.

FIG. 5 is an illustration of a ATV (utility-terrain vehicle) 602 comprising an integrated battery charger comprising an ATV trunk.

FIG. 6 illustrates a schematic block diagram of a conceptual computer system 500 used to implement some embodiments. For example, the system described with reference to the disclosure and Figures herein may be at least partially implemented using computer system 500.

### DETAILED DESCRIPTION OF THE EMBODIMENTS

The following is a detailed description of certain specific embodiments of the integrated battery charger and methods disclosed herein.

In one aspect, disclosed herein is an integrated battery charger, comprising: a) a motorcycle hand guard, a snowmobile hand guard or an ATV (all-terrain vehicle) hand guard; and b) a battery charger, comprising i) a solar panel integrated into the hand guard and positioned to generate electricity when the solar panel is exposed to ambient light, the solar panel being operable to charge a battery, and ii) one or more cables capable of being in electrical communication with the motorcycle battery, snowmobile battery or the ATV battery.

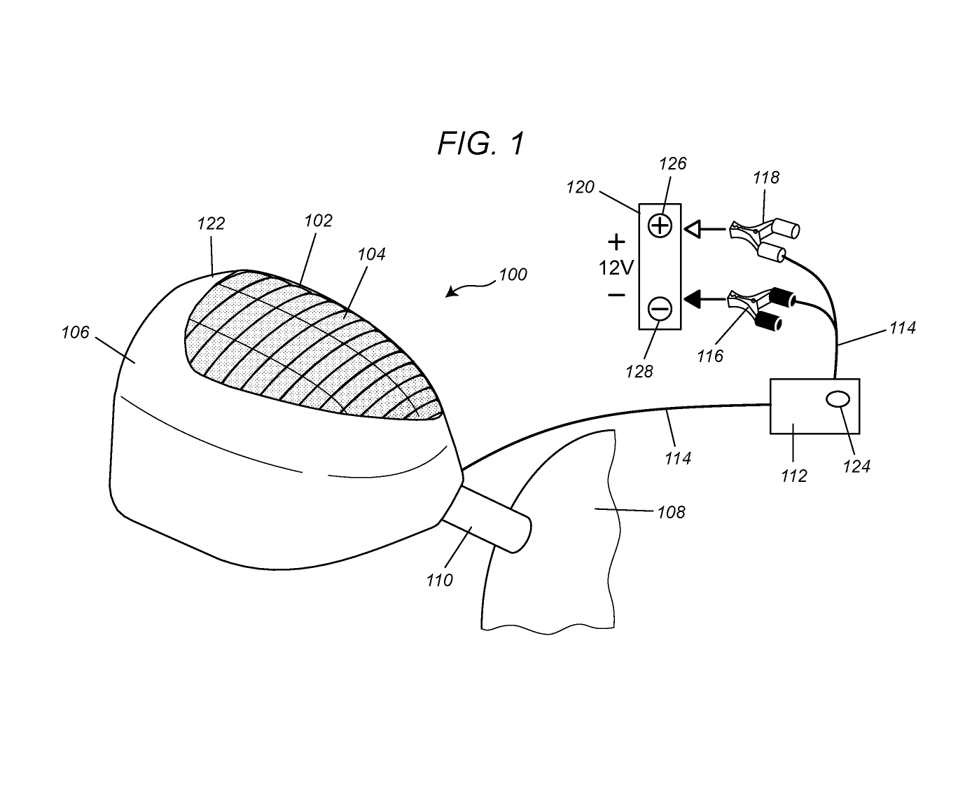

Turning to the drawings, FIG. 1 is an illustration of a hand guard integrated battery charger 100 comprising a motorcycle hand guard, a snowmobile hand guard or an ATV (all-terrain vehicle) hand guard 106. The hand guard integrated battery charger 100 employs a solar panel 102 comprising one or more solar cells 104 with the solar panel being integrated with a top portion 122 of the hand guard 106. The hand guard integrated solar panel 102 is in electrical communication with a battery 120 of the motorcycle, snowmobile or ATV via cables 114 that terminate with clamps 116 and 118, which are attached to battery terminals 126 and 128. In some embodiments, the solar panel is affixed to a top portion of the motorcycle hand guard, a top portion of the snowmobile hand guard or a top portion of the ATV hand guard.

In another aspect, disclosed herein is an integrated battery charger, comprising: a) a motorcycle mirror, an ATV (all-terrain vehicle) mirror or a UTV (utility-terrain vehicle) mirror; and b) a battery charger, comprising i) a solar panel integrated into the mirror and positioned to generate electricity when the solar panel is exposed to ambient light, the solar panel being operable to charge a battery, and ii) one or more cables capable of being in electrical communication with a motorcycle battery, an ATV or a UTV battery.

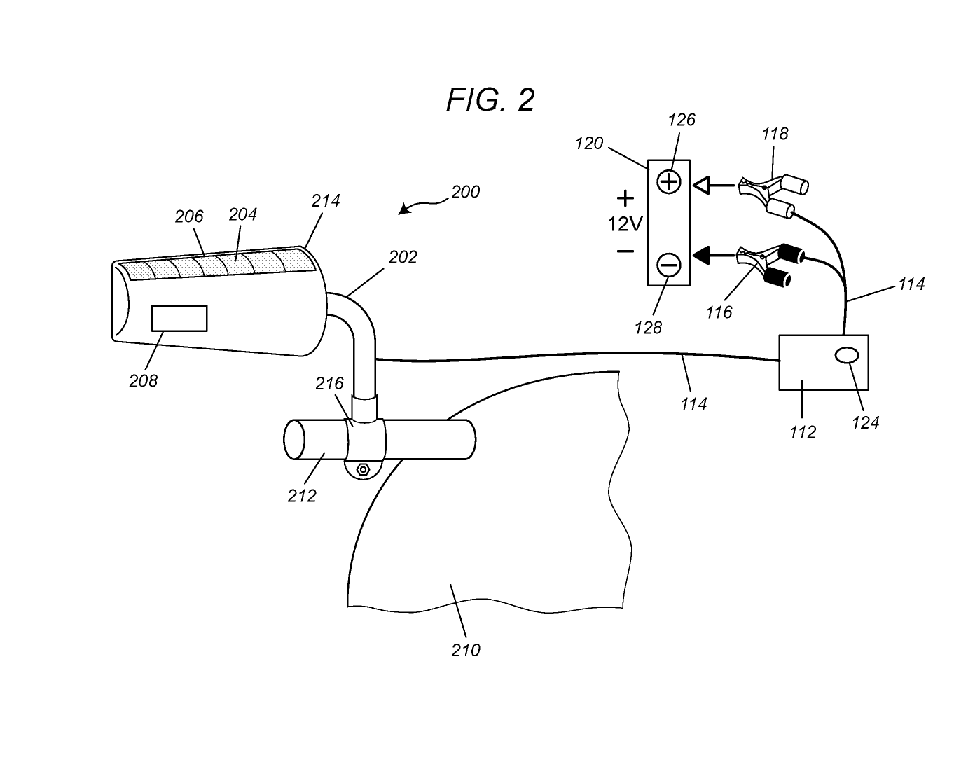

Turning to the drawings, FIG. 2 is an illustration of a mirror integrated battery charger 200 comprising a motorcycle mirror, an ATV (all-terrain vehicle) mirror or a UTV (utility-terrain vehicle) mirror 202. The mirror integrated battery charger 200 employs a solar panel 206 comprising one or more solar cells 204 with the solar panel being integrated with a top portion 214 of the mirror 202. The mirror integrated solar panel 206 is in electrical communication with a battery 120 of the motorcycle or ATV via cables 114 that terminate with clamps 116 and 118, which are attached to battery terminals 126 and 128. In some embodiments, the solar panel is affixed to a top portion of the motorcycle mirror, affixed to a top portion of the ATV mirror or affixed to a top portion of the UTV mirror. In some embodiments, the solar panel is affixed to a top portion of the motorcycle mirror, affixed to a top portion of the ATV mirror or affixed to a top portion of the UTV mirror is mounted to a handle bar, frame tubing, etc. 212 via mirror clamp 216.

In another aspect, disclosed herein is an integrated battery charger, comprising: a) a personal watercraft steering pad and/or a personal watercraft steering pad cover; and b) a battery charger, comprising i) a solar panel integrated into the steering pad and/or steering pad cover and positioned to generate electricity when the solar panel is exposed to ambient light, the solar panel being operable to charge a battery, and ii) one or more cables capable of being in electrical communication with a personal watercraft battery.

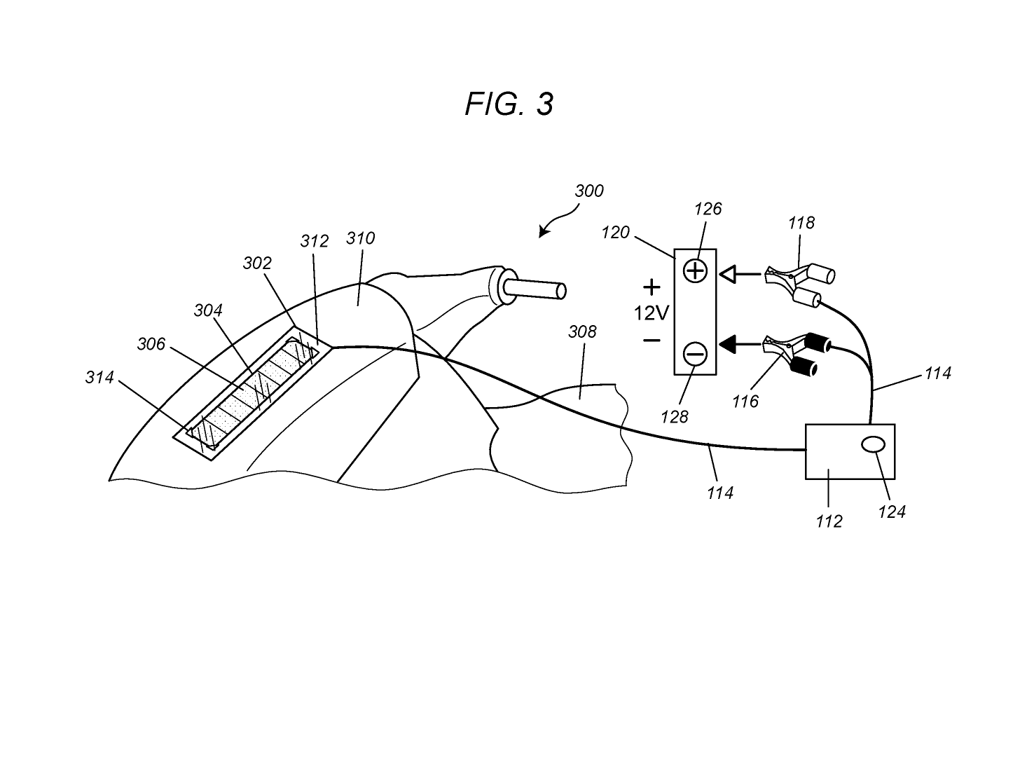

Turning to the drawings, FIG. 3 is an illustration of a personal watercraft integrated battery charger 300 comprising a personal watercraft steering pad and/or a personal watercraft steering pad cover 310. The personal watercraft integrated battery charger 300 employs a solar panel 304 comprising one or more solar cells 306 with the solar panel being integrated with a top portion of the personal watercraft steering pad and/or a personal watercraft steering pad cover 310 via steering pad and/or steering pad cover opening 302. The personal watercraft integrated solar panel 304 is in electrical communication with a battery 120 of the personal watercraft via cables 114 that terminate with clamps 116 and 118, which are attached to battery terminals 126 and 128. In some embodiments, the solar panel 304 is protected with a clear panel portion 312 and the solar panel 304 is affixed to an underside of the clear panel portion 312 and/or the personal watercraft steering pad and/or a personal watercraft steering pad cover 310 with fasteners 314. In some embodiments, the solar panel is integrated with the personal watercraft steering pad and/or the personal watercraft steering pad cover, wherein the solar panel is about flush with a top surface of the personal watercraft steering pad and/or a top surface of the personal watercraft steering pad cover.

In some embodiments, the solar panel is integrated with the personal watercraft steering pad and/or the personal watercraft steering pad cover and further comprises a clear panel portion protecting the solar panel that is about flush with a top portion of the personal watercraft steering pad and/or a top surface of the personal watercraft steering pad cover.

In some embodiments, the solar panel is integrated with the personal watercraft steering pad and/or the personal watercraft steering pad cover and further comprises a clear panel portion protecting the solar panel that is about flush with a top portion of the personal watercraft steering pad and/or a top surface of the personal watercraft steering pad cover, wherein the solar panel is mounted to an underside portion of the clear panel portion.

In some embodiments, the solar panel is integrated with the personal watercraft steering pad and/or the personal watercraft steering pad cover and further comprises a clear panel portion protecting the solar panel that is about flush with a top portion of the personal watercraft steering pad and/or a top surface of the personal watercraft steering pad cover, wherein the solar panel is mounted to an underside portion of the clear panel portion and/or an underside portion of the personal watercraft steering pad and/or an underside portion of the personal watercraft steering pad cover.

In another aspect, disclosed herein is an integrated battery charger, comprising: a) a UTV (utility-terrain vehicle) roof; and b) a battery charger, comprising i) a solar panel integrated into the roof and positioned to generate electricity when the solar panel is exposed to ambient light, the solar panel being operable to charge a battery, and ii) one or more cables capable of being in electrical communication with a UTV battery.

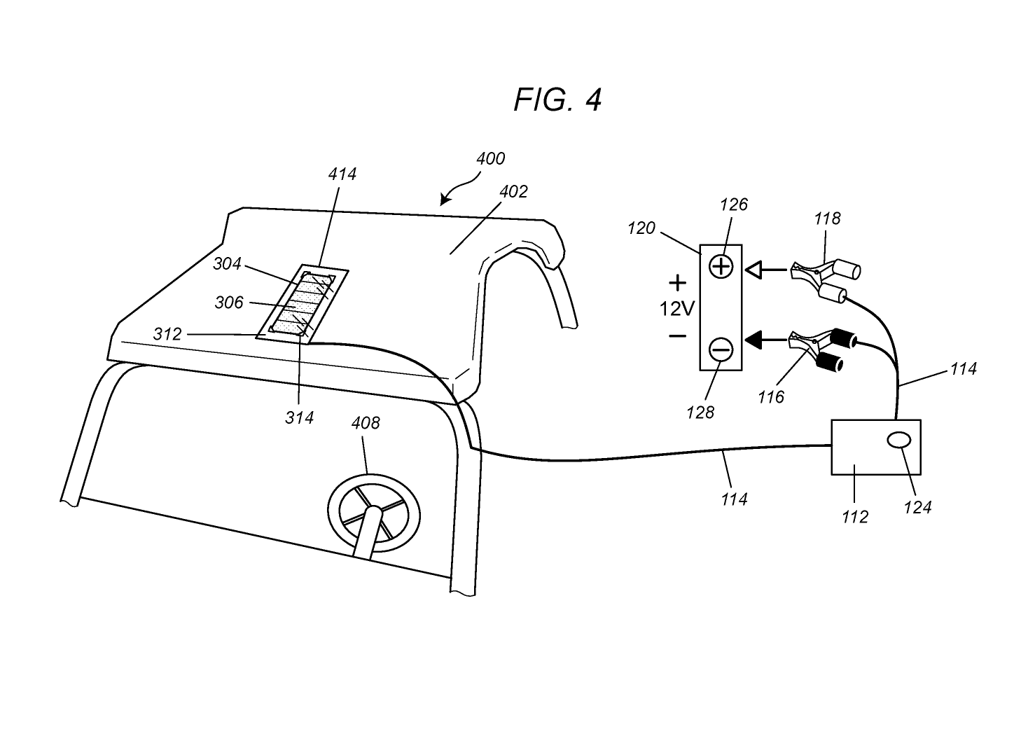

Turning to the drawings, FIG. 4 is an illustration of a UTV (utility-terrain vehicle) integrated battery charger 400 comprising a UTV roof 402. The UTV integrated battery charger 400 employs a solar panel 304 comprising one or more solar cells 306 with the solar panel being integrated with a top portion of the UTV roof 402 via UTV roof opening 414. The UTV integrated solar panel 304 is in electrical communication with a battery 120 of the UTV via cables 114 that terminate with clamps 116 and 118, which are attached to battery terminals 126 and 128. In some embodiments, the solar panel 304 is protected with a clear panel portion 312 and the solar panel 304 is affixed to an underside of the clear panel portion 312 and/or the UTV roof 402 with fasteners 314. In some embodiments, the solar panel is integrated with the UTV roof, wherein the solar panel is about flush with a top surface of the UTV roof.

In some embodiments, the solar panel is integrated with the UTV roof and further comprises a clear panel portion protecting the solar panel that is about flush with a top portion of the UTV roof.

In some embodiments, the solar panel is integrated with the UTV roof and further comprises a clear panel portion protecting the solar panel that is about flush with a top portion of the UTV roof, wherein the solar panel is mounted to an underside portion of the clear panel portion.

In some embodiments, the solar panel is integrated with the UTV roof and further comprises a clear panel portion protecting the solar panel that is about flush with a top portion of the UTV roof, wherein the solar panel is mounted to an underside portion of the clear panel portion and/or an underside portion of the UTV roof.

In another aspect, disclosed herein is an integrated battery charger, comprising: a) a motorcycle saddle bag or an ATV (all-terrain vehicle) trunk; and b) a battery charger, comprising i) a solar panel integrated into the hand guard and positioned to generate electricity when the solar panel is exposed to ambient light, the solar panel being operable to charge a battery, and ii) one or more cables in electrical communication with the motorcycle battery or the ATV battery.

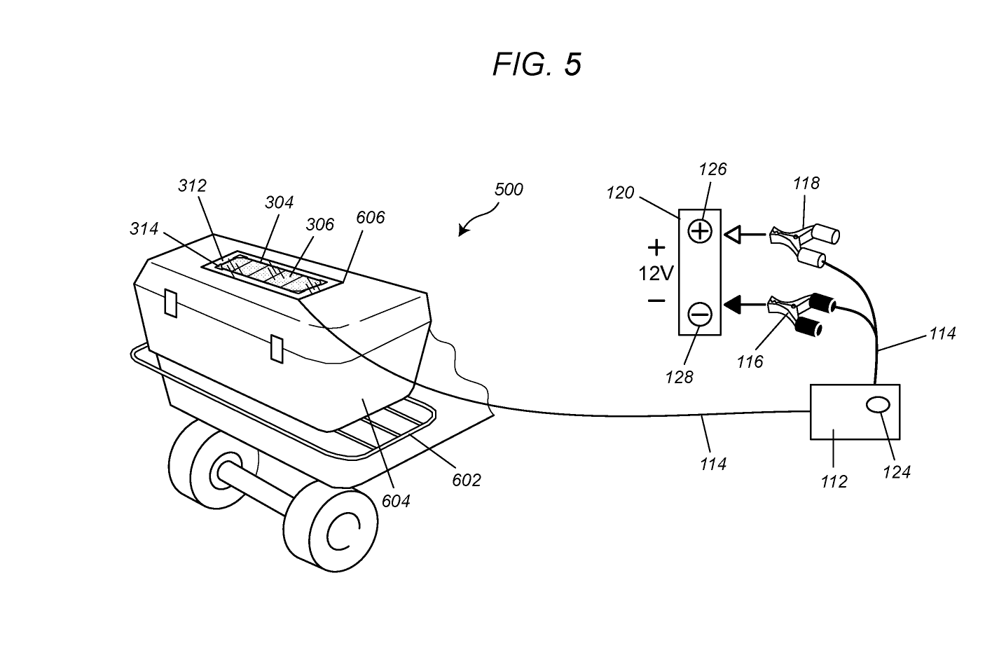

Turning to the drawings, FIG. 5 is an illustration of an ATV (all-terrain vehicle) integrated battery charger 600 comprising an ATV trunk 604. The ATV integrated battery charger 600 employs a solar panel 304 comprising one or more solar cells 306 with the solar panel being integrated with a top portion of the ATV trunk 604 via ATV trunk opening 606. The UTV integrated solar panel 304 is in electrical communication with a battery 120 of the personal watercraft via cables 114 that terminate with clamps 116 and 118, which are attached to battery terminals 126 and 128. In some embodiments, the solar panel 304 is protected with a clear panel portion 312 and the solar panel 304 is affixed to an underside of the clear panel portion 312 and/or the ATV trunk 604 with fasteners 314. In some embodiments, the solar panel is integrated with the motorcycle saddle bag or the ATV trunk, wherein the solar panel is about flush with a top surface of the motorcycle saddle bag or the ATV trunk.

In some embodiments, the solar panel is integrated with the motorcycle saddle bag or the ATV trunk and further comprises a clear panel portion protecting the solar panel that is about flush with a top portion of the motorcycle saddle bag or the ATV trunk.

In some embodiments, the solar panel is integrated with the motorcycle saddle bag or the ATV trunk and further comprises a clear panel portion protecting the solar panel that is about flush with a top portion of the motorcycle saddle bag or the ATV trunk, wherein the solar panel is mounted to an underside portion of the clear panel portion.

In some embodiments, the solar panel is integrated with the motorcycle saddle bag or the ATV trunk and further comprises a clear panel portion protecting the solar panel that is about flush with a top portion of the motorcycle saddle bag or the ATV trunk, wherein the solar panel is mounted to an underside portion of the clear panel portion and/or an underside portion of the motorcycle saddle bag or the ATV trunk.

In some embodiments, the integrated battery charger further comprises a controller that operates to disconnect the solar panel from the battery when the battery is fully charged. In some embodiments, the integrated battery charger further comprises a controller that operates to disconnect said solar panel from said booster battery when said charger is powered. In some embodiments, the integrated battery charger further comprises a controller with a relay that is in electronic communication with the solar panel and that the relay operates to disconnect said solar panel from said booster battery when said charger is powered. In some embodiments, the solar panel has a wattage between about 5 Watts and 25 Watts.

In another aspect, disclosed herein is method of maintaining a charge on a battery, comprising: a) providing a battery charger, comprising i) a solar panel on said support positioned to generate electricity when said support is exposed to said ambient light, said solar panel being operable to charge said booster battery when so exposed, and ii) one or more cables capable of being in electrical communication with a motorcycle battery or an ATV battery, wherein the solar panel is integrated with a motorcycle hand guard, a solar panel integrated with a snowmobile hand guard, a solar panel integrated with an ATV hand guard, a solar panel integrated with a motorcycle mirror, a solar panel integrated with an ATV mirror or a solar panel integrated with a personal watercraft steering pad and/or a personal watercraft steering pad cover; b) switching the motorcycle, snowmobile, ATV or personal watercraft ignition to an off position; and c) charging a battery via the battery charger with the solar panel exposed to sunlight. In some embodiments, the step of charging is performed automatically. The battery charger of the subject disclosure is an integrated battery charger that remains with the vehicle and during outdoor storage the solar panel of the battery charger is capable of maintaining a charge with the battery. During installation of the integrated battery charger the clamps are connected in a conventional manner onto the battery posts of the battery, the clamps 116 and 118 being configured conventionally using clamps suitable for motorcycle, snowmobile, ATV, personal watercraft or UTV battery posts 126 and 128.

An integrated battery charger of the subject disclosure may employ various types of solar panels or their functional equivalent, and it may be mounted so that it is exposed to a source of light energy, preferably facing upwardly toward the sky so that solar energy impinges upon it as depicted with FIGS. 1-5. The integrated battery charger may employ commercially available, high efficiency solar panel voltage selected with a voltage between 5 to 25 volts. In addition, the integrated battery charger includes overcharge protection provided by the controller 112 and/or relay 124.

Thus, the subject disclosure provides an integrated battery charger employing a solar panel. The battery charger provides a trickle charge to the vehicle's battery as long as there is sufficient light which serves to maintain the battery at full charge despite extended periods without use. In some embodiments, the battery charger is a Deltran Solar Powered Battery Tender® that has been modified to be integrated as disclosed herein.

### Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be adapted to perform functions and/or features that may be associated with various software elements described throughout.

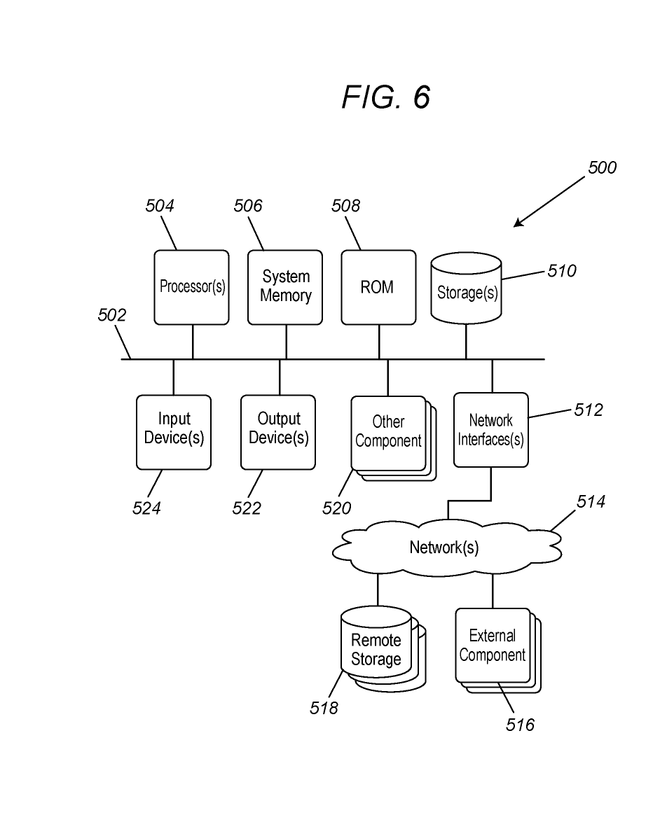

Referring to the drawings, FIG. 6 illustrates a schematic block diagram of a conceptual computer system 500 used to implement some embodiments. For example, the system described above in reference to FIGS. 1-5 may be at least partially implemented using all or a portion of computer system 500.

Computer system 500 may be implemented using various appropriate devices. For instance, the computer system may be implemented using one or more vehicle display units, personal computers (PCs), servers, mobile devices (e.g., a smartphone), tablet devices, and/or any other appropriate devices. The various devices may work alone (e.g., the computer system may be implemented as a vehicle display unit) or in conjunction (e.g., some components of the computer system may be provided by a vehicle display unit while other components may be provided by a tablet device).

As shown, computer system 500 may include at least one communication bus 502, one or more processors 504, a system memory 506, a read-only memory (ROM) 508, permanent storage devices 510, input devices 524, output devices 522, various other components 520 (e.g., a graphics processing unit), and one or more network interfaces 512 and may include a network 514, corresponding remote storage 518 and a corresponding external component 516.

Communication bus 502 represents all communication pathways among the elements of computer system 500. Such pathways may include wired, wireless, optical, and/or other appropriate communication pathways. For example, input devices 524 and/or output devices 522 may be coupled to the system 500 using a wireless connection protocol or system.

The processor 504 may, in order to execute the processes of some embodiments, retrieve instructions to execute and/or data to process from components such as system memory 506, ROM 508, and permanent storage device 510. Such instructions and data may be passed over bus 502.

System memory 506 may be a volatile read-and-write memory, such as a random access memory (RAM). The system memory may store some of the instructions and data that the processor uses at runtime. The sets of instructions and/or data used to implement some embodiments may be stored in the system memory 506, the permanent storage device 510, and/or the read-only memory 508. ROM 508 may store static data and instructions that may be used by processor 504 and/or other elements of the computer system.

Permanent storage device 510 may be a read-and-write memory device. The permanent storage device may be a non-volatile memory unit that stores instructions and data even when computer system 500 is off or unpowered. Computer system 500 may use a removable storage device and/or a remote storage device as the permanent storage device.

Input devices 524 may enable a user to communicate information to the computer system and/or manipulate various operations of the system. The input devices may include keyboards, cursor control devices, audio input devices and/or video input devices. Output devices 522 may include printers, displays, and/or audio devices. Some or all of the input and/or output devices may be wirelessly or optically connected to the computer system.

Other components 520 may perform various other functions. These functions may include performing specific functions (e.g., graphics processing, sound processing, etc.), providing storage, interfacing with external systems or components, etc.

Referring to FIG. 6, computer system 500 may be coupled to one or more networks 514 through one or more network interfaces 512. For example, computer system 500 may be coupled to a web server on the Internet such that a web browser executing on computer system 500 may interact with the web server as a user interacts with an interface that operates in the web browser. Computer system 500 may be able to access one or more remote storages 518 and one or more external components 516 through the network interface 512 and network 514. The network interface(s) 512 may include one or more application programming interfaces (APIs) that may allow the computer system 500 to access remote systems and/or storages and also may allow remote systems and/or storages to access computer system 500 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 500 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

### Definitions

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or devices, which can of course vary. It is also to be understood that the terminology used herein is for the purpose of describing particular embodiments only, and is not intended to be limiting.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

What is claimed is:

1. An integrated battery charger, comprising:
a) a battery charger, comprising
i. a solar panel positioned to generate electricity when the solar panel is exposed to said ambient light, the solar panel being operable to charge a battery, and
ii. one or more cables in electrical communication with a motorcycle battery, a snowmobile battery, an ATV (all-terrain vehicle) battery, a UTV (utility-terrain vehicle) battery or a personal watercraft battery,
wherein the battery charger is integrated into a motorcycle, a snowmobile, an ATV (all-terrain vehicle), a snow mobile, a UTV (utility-terrain vehicle) or a personal watercraft.

2. The integrated battery charger of claim 1, comprising:
a) a motorcycle hand guard, a snowmobile hand guard or an ATV (all-terrain vehicle) hand guard; and
b) a battery charger, comprising
i. a solar panel integrated into the hand guard and positioned to generate electricity when the solar panel is exposed to ambient light, the solar panel being operable to charge a battery, and
ii. one or more cables in electrical communication with the motorcycle battery, the snowmobile battery or the ATV battery.

3. The integrated battery charger of claim 1, comprising:
a) a motorcycle mirror, an ATV (all-terrain vehicle) mirror or a UTV (utility-terrain vehicle) mirror; and
b) a battery charger, comprising
i. a solar panel integrated into the mirror and positioned to generate electricity when the solar panel is exposed to ambient light, the solar panel being operable to charge a battery, and
ii. one or more cables in electrical communication with a motorcycle battery, an ATV or a UTV battery.

4. The integrated battery charger of claim 1, comprising:
a) a personal watercraft steering pad and/or a personal watercraft steering pad cover; and
b) a battery charger, comprising
i. a solar panel integrated into the steering pad and/or steering pad cover and positioned to generate electricity when the solar panel is exposed to ambient light, the solar panel being operable to charge a battery, and
ii. one or more cables in electrical communication with a personal watercraft battery.

5. The integrated battery charger of claim 1, comprising:
a) a UTV (utility-terrain vehicle) roof; and
b) a battery charger, comprising
i. a solar panel integrated into the roof and positioned to generate electricity when the solar panel is exposed to ambient light, the solar panel being operable to charge a battery, and
ii. one or more cables in electrical communication with a UTV battery.

6. The integrated battery charger of claim 1, comprising:
a) a motorcycle saddle bag or an ATV (all-terrain vehicle) trunk; and
b) a battery charger, comprising
iii. a solar panel integrated into the hand guard and positioned to generate electricity when the solar panel is exposed to ambient light, the solar panel being operable to charge a battery, and
iv. one or more cables in electrical communication with the motorcycle battery or the ATV battery.

7. The battery charger of claim 1, further comprising a controller that operates to disconnect the solar panel from the battery when the battery is fully charged.

8. The battery charger of claim 1, wherein the solar panel has a wattage between about 5 Watts and 25 Watts.

9. The battery charger of claim 2, wherein the solar panel is affixed to a top portion of the motorcycle hand guard, a top portion of the snowmobile hand guard or a top portion of the ATV hand guard.

10. The battery charger of claim 3, wherein the solar panel is affixed to a top portion of the motorcycle mirror, affixed to a top portion of the ATV mirror or affixed to a top portion of the UTV mirror.

11. The battery charger of claim 4, wherein the solar panel is integrated with the personal watercraft steering pad and/or the personal watercraft steering pad cover, wherein the solar panel is about flush with a top surface of the personal watercraft steering pad and/or a top surface of the personal watercraft steering pad cover.

12. The battery charger of claim 4, wherein the solar panel is integrated with the personal watercraft steering pad and/or the personal watercraft steering pad cover and further comprises a clear panel portion protecting the solar panel that is about flush with a top portion of the personal watercraft steering pad and/or a top surface of the personal watercraft steering pad cover.

13. The battery charger of claim 4, wherein the solar panel is integrated with the personal watercraft steering pad and/or the personal watercraft steering pad cover and further comprises a clear panel portion protecting the solar panel that is about flush with a top portion of the personal watercraft steering pad and/or a top surface of the personal watercraft steering pad cover, wherein the solar panel is mounted to an underside portion of the clear panel portion.

14. The battery charger of claim 5, wherein the solar panel is integrated with the UTV roof, wherein the solar panel is about flush with a top surface of the UTV roof.

15. The battery charger of claim 5, wherein the solar panel is integrated with the UTV roof and further comprises a clear panel portion protecting the solar panel that is about flush with a top portion of the UTV roof.

16. The battery charger of claim 5, wherein the solar panel is integrated with the UTV roof and further comprises a clear panel portion protecting the solar panel that is about flush with a top portion of the UTV roof, wherein the solar panel is mounted to an underside portion of the clear panel portion.

17. The battery charger of claim 6, wherein the solar panel is integrated with the motorcycle saddle bag or the ATV trunk, wherein the solar panel is about flush with a top surface of the motorcycle saddle bag or the ATV trunk.

18. The battery charger of claim 6, wherein the solar panel is integrated with the motorcycle saddle bag or the ATV trunk and further comprises a clear panel portion protecting the solar panel that is about flush with a top portion of the motorcycle saddle bag or the ATV trunk.

19. The battery charger of claim 6, wherein the solar panel is integrated with the motorcycle saddle bag or the ATV trunk and further comprises a clear panel portion protecting the solar panel that is about flush with a top portion of the motorcycle saddle bag or the ATV trunk, wherein the solar panel is mounted to an underside portion of the clear panel portion.

20. A method of maintaining a charge on a battery, comprising:
a) providing a battery charger, comprising
i. a solar panel on said support positioned to generate electricity when said support is exposed to said ambient light, said solar panel being operable to charge said booster battery when so exposed, and
ii. one or more cables capable of being in electrical communication with a motorcycle battery, a snowmobile battery, an ATV (all-terrain vehicle) battery, a UTV (utility-terrain vehicle) battery or a personal watercraft battery.
wherein the solar panel is integrated with a motorcycle hand guard, a solar panel integrated with a snowmobile hand guard, a solar panel integrated with an ATV hand guard, a solar panel integrated with a motorcycle mirror, a solar panel integrated with an ATV mirror, a solar panel integrated with a personal watercraft steering pad and/or a personal watercraft steering pad cover, a UTV roof, a motorcycle saddle bag or an ATV trunk;
b) switching the motorcycle, snowmobile, ATV, personal watercraft or UTV ignition to an off position; and
c) charging the battery via the battery charger with the solar panel exposed to sunlight, wherein the step of charging is performed automatically.
